(19) United States
(12) Patent Application Publication
(10) Pub. No.: US 2005/0076150 A1
(43) Pub. Date: Apr. 7, 2005

(54) Home network system and method for operating the same

(75) Inventors: Sang Kyun Lee, Kyungki-do (KR); Oh Sung Kwon, Kyungki-do (KR); Yeon Kyoung Lee, Kyungki-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/875,746

(22) Filed: Jun. 23, 2004

(30) Foreign Application Priority Data
Oct. 1, 2003 (KR) 2003-68351

(51) Int. Cl. G06F 15/16

(52) U.S. Cl. 709/249; 340/825; 700/1

(57) ABSTRACT

A home network system and a method for operating the same. The home network system includes a bridge capable of performing the conversion of communication standards of messages communicated between networks having different communication standards. The home network system includes a control network connected to a plurality of home appliances based on different communication standards for every production company, a UPnP (Universal Plug and Play) network connected to a plurality of home appliances based on an UPnP communication standard, and a bridge for composing/listening to a message communicated between the control network and the UPnP network so that it carries out mutual-communication standard conversion. Therefore, the home network system increases compatibility so that different network devices connected to the same network can be interoperable with each other, resulting in increased reliability of an overall network system.

### BACKGROUND OF THE INVENTION

1. Field of the Invention

The present invention relates to a home network system, and more particularly to a home network system and a method for operating the same, which can facilitate control operations using a UPnP bridge capable of performing the conversion of a message communication standard communicated between networks having different communication standards.

2. Description of the Related Art

Typically, a home network system is indicative of a system in which a PC (Personal Computer) and a plurality of home appliances are interconnected over a network to establish data transmission/reception between them, such that it can perform mutual-monitoring or control operations. A conventional home network system will hereinafter be described with reference to FIG. 1.

An administrator of a network N constructed in buildings can enter his or her desired control command in a plurality of home appliances h1, h2, h3, and h4 connected to the network N, and can also recognize state information of home appliances operated by the control command.

For the aforementioned operations, there is a need for a new home appliance to control not only the flow of signals communicating with the network N, but also connection states of individual home appliances, such a new home appliance is called a home server 30. The home server 30 is driven as an independent computer during a predetermined time such as 24 hours, such that it can perform a server function, or can allow home appliances (e.g., an Internet refrigerator) each equipped with I/O (Input/Output) units and processors, to further perform such a server function. It should be noted that the conventional art and the present invention will disclose such an Internet refrigerator acting as a home server 30 for illustrative purposes.

The home server 30 switches signals communicated between home appliances h1, h2, h3, and h4 connected to the network N, can directly receive a control command from an entry unit (not shown), and can recognize the result of control operations using an output unit (not shown).

The home server 30 includes hardware systems, such as a network card and an Internet modem, to access an external Internet I, such that it can carry out not only inner-control operations using the network N, but also outer-control operations of home appliances using a remote controller 50 accessing the Internet.

In more detail, a user who acts as a remote-control administrator gains access to a Webpage enabled by a portal server 40 capable of controlling home network systems of individual buildings, and can control or monitor predetermined home appliances accessing a corresponding network.

A network modem (not shown) is contained in the home appliances h1, h2, h3, and h4 to allow signals to communicate with the network N, and a microprocessor for performing necessary operations according to a control signal transmitted over the network N is also contained in the home appliances h1, h2, h3, and h4 so that a message indicative of the control result is fed back to the home server 30.

In order to allow the home network system to perform the aforementioned operations, home appliances connected to the Internet N must generate and process signals having the same communication standards. In more detail, individual manufacturing companies must develop their unique communication standards or other communication standards before a prescribed communication standard of the home network system is officially determined, such that a variety of home appliances for the network have recently been introduced to the market.

A representative communication standard adapted for most home appliances is an UPnP (Universal Plug and Play) standard. This UPnP standard has been developed by a variety of prominent companies, for example, Intel, 3COM, Cisco, Dell, Ericsson, Nokia, Philips, LG, and Samsung Corporations.

In the case where a home appliance having the above UPnP communication standard gains access to the network N, and a network-purpose home appliance manufactured based on other communication standards different from the UPnP communication standard gains access to the network N, the home server 30 cannot recognize the home appliance, resulting in no compatibility although it is connected to the same network N.

Therefore, a customer who has purchased a network-purpose home appliance with a communication standard other than the UPnP communication standard cannot freely use a network function implemented in his or her home appliance due to lack of compatibility of the home appliance, resulting in deterioration of home-appliance use efficiency.

Manufacturing companies which have selected different communication standards must convert a conventional communication standard into another standard, or must develop an additional device capable of supporting the compatibility with different communication standards, resulting in increased production costs.

### SUMMARY OF THE INVENTION

Therefore, the present invention has been made in view of the above problems, and it is an object of the invention to provide a home network system and a method for operating the same, which can provide a UPnP bridge capable of performing the conversion of communication standards to enable a message communicated between networks having different communication standards to be recognized by the networks, such that it can allow a plurality of home appliances to interact with each other regardless of communication standards, and can improve use efficiency of network functions implemented in the home appliances, resulting in greater convenience for a user.

In accordance with one aspect of the present invention, these objects are accomplished by providing a home network system comprising: a control network connected to a plurality of home appliances based on different communication standards for every production company; a UPnP (Universal Plug and Play) network connected to a plurality of home appliances based on an UPnP communication standard; and a bridge for composing/listening to a message communicated between the control network and the UPnP network so that it carries out mutual-communication standard conversion.

In accordance with another aspect of the present invention, there is provided a method for operating a home network system including a bridge capable of performing mutual conversion of communication standards to implement message transmission/reception between UPnP (Universal Plug and Play) communication standard-based home appliances and other communication standards-based home appliances connected to the same network, the method comprising the steps of: a) allowing the bridge to refer to a subscription table for storing product information associated with home appliances connected to the network, thereby receiving event information from the home appliances having communication standards other than the UPnP communication standard; b) composing a UPnP message including a corresponding UPnP network address according to the subscription table; and c) transmitting the composed UPnP message to a home server so that operations of home appliances associated with the control network are controlled.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic diagram illustrating a conventional home network system;

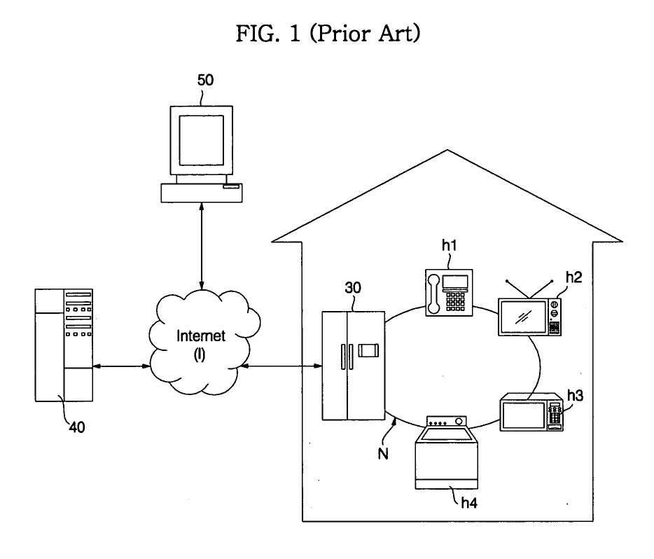

FIG. 2 is a block diagram illustrating a home network system in accordance with the present invention;

FIG. 3 is a detailed block diagram illustrating the home network system in accordance with the present invention; and

FIG. 4 is a flow chart illustrating an operation method of the home network system in accordance with the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

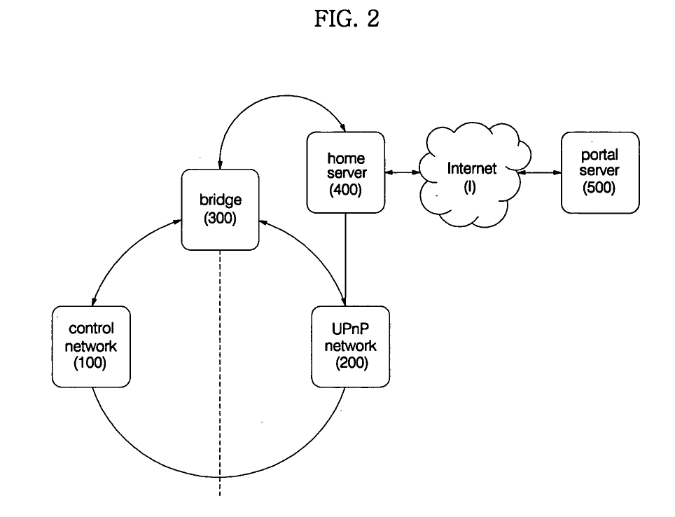

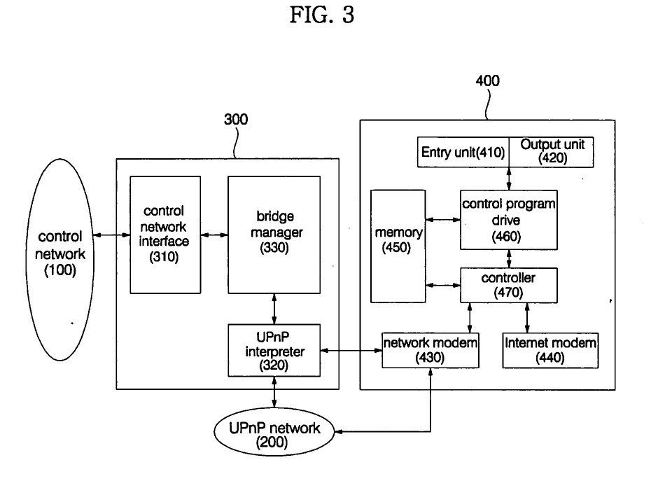

A home network system of the present invention will hereinafter be described with reference to FIGS. 2 and 3. FIG. 2 is a block diagram illustrating a home network system in accordance with the present invention. FIG. 3 is a detailed block diagram illustrating the home network system in accordance with the present invention.

The UPnP (Universal Plug and Play) communication standard has been developed by a variety of manufacturing companies (e.g., about 150 companies) such as Microsoft, Intel, Compaq, Misubishi, Philips, and Sony Corporations, etc., which have defined PC-based home appliance control software (S/W) standards, such that it can facilitate a connection between home appliances in network environments including phone lines, power lines, and wireless equipment, etc. using a TCP/IP scheme. The UPnP communication standard can implement a Plug and Play function even though it does not use a PC, such that a plurality of companies have widely adapted the UPnP communication standard to their products.

In addition to the aforementioned UPnP communication standard, there are other communication standards for a home-appliance networking function, for example, LnCP, HNCp, and Lontalk, etc., such that there have been widely used a plurality of home appliances adapting the above communication standards.

A network to which home appliances based on different communication standards other than the UPnP communication standard are connected is called a control network 100, and a UPnP-based network is called a UPnP network 200. In this case, it is assumed that a home appliance of the control network 100 is based on an HNCP communication standard for illustrative purposes.

The control network 100 and the UPnP network 200 are connected to the same network to configure individual networks, and are connected to the bridge 300 capable of switching/processing messages between networks having different communication standards, resulting in the creation of a home network system.

In this case, it is assumed that the home server 400 for administrating/controlling a plurality of home appliances connected to the network is connected to a platform equal to that of the bridge 300, and the home server 400 and the bridge 300 are contained in the UPnP network.

Referring to FIG. 3, the home server 400 includes an entry unit 410 for receiving an operation control command of a home appliance or a control command for Internet access implementation from a user, and an output unit 420 for displaying the result of the control commands. In this case, the entry unit 310 and the output unit 420 are each configured in the form of an integrated touch screen, such that they can receive desired control commands from a user who presses a few buttons or is brought in contact with the touch screen.

The home server 400 includes an Internet modem 440 capable of performing signal communication over the Internet, such that it can gain access to the portal server 500 capable of controlling a plurality of home network systems. Therefore, the home server 400 receives a control command signal entered on a Webpage driven by the portal server 500 from a remote-control user, and transmits the received control command signal to a corresponding home appliance, resulting in the implementation of a remote control function.

The home server 400 includes a network modem 430 capable of communicating with a plurality of home appliances accessing the home server 400 over the network. Where the accessed home appliances are contained in the UPnP network, the home server 400 can perform direct signal transmission. Where the accessed home appliances are contained in the control network, the home server 400 can perform signal transmission through the use of the bridge 300 capable of performing a mutual-conversion process of protocols.

In order to enter a control command for controlling operations of the accessed home appliances or monitoring state information of the same, or recognize the result of the control command, the home server 400 includes a control program drive 460 by which a control program capable of performing a user-interface function is driven.

The control program drive 460 and a memory 450 storing device- and user-information of a plurality of home appliances connected to the network are connected to the controller 470 of the home server 400, such that the controller 470 generates a control signal according to a user control command entered by the control program to carry out a corresponding operation.

The present invention discloses an Internet refrigerator acting as the home server 400 for illustrative purposes. Provided that a home appliance is implemented with a controller 470 capable of processing data communicating with a plurality of other home appliances connected to the network and a memory 450 for storing unique product information of the home appliance, the home server 400 can freely use the home appliance regardless of category information of the home appliance.

The bridge 300 for use in the home network system of the present invention composes or listens to messages communicated between the control network 100 and the UPnP network 200, such that it can carry out the conversion of the mutual-communication standard. The bridge 300 is implemented with an independent system, such that it is connected to the home server 400. Otherwise, the bridge 300 is implemented with a software module, such that it can be directly implemented in the home server.

The bridge 300 includes a control network interface 310 for composing/listening to a message based on a communication standard of the control network 100, a UPnP interpreter 320 for composing/listening to a UPnP-communication-standard-based message communicating with the UPnP network 200, and a bridge manager 330 for converting communication standards of messages transmitted/received via the control network interface 310 and the UPnP interpreter 320 into another communication standard.

The bridge manager 330 manages unique network addresses assigned to individual home appliances contained in the control network 100, and dynamically generates/assigns individual UPnP network addresses of the home appliances. The bridge manager 330 stores the assigned UPnP network addresses in the form of a file, such that it can re-use the UPnP network address even though an overall system is rebooted.

The above file has a predetermined packet configuration denoted by {UPnP network address|HNCP network address|UPnP device type|Model name|Product state|Product expiration time|UPnP document's URL|}, and configures a subscription table.

In more detail, the bridge manager 330 assigns corresponding UPnP network addresses to network addresses of individual home appliances, such that the UPnP network 200 can recognize home appliances contained in the control network 100. As a result, the bridge manager 330 converts a message communication standard in response to event information generated from the home appliances into the UPnP communication standard.

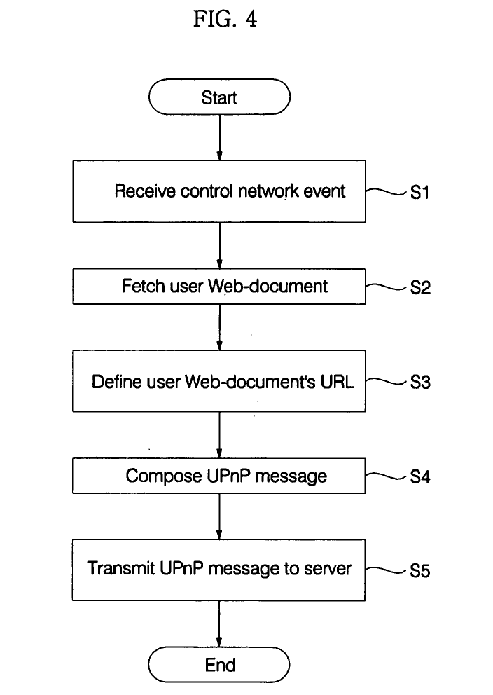

FIG. 4 is a flow chart illustrating an operation method of the home network system in accordance with the present invention.

The bridge receives event information from an HNCP home appliance contained in the control network with reference to a subscription table for storing product information associated with home appliances connected to the network and expiration time information (i.e., effective time information) of the product information at step S1.

The bridge fetches a user Web-document U1 associated with individual HNCP home appliances at step S2, and a URL (Uniform Resource Locator) of a current operation platform of the bridge is indicated, as a URL where the user Web-document currently exists, on UPnP messages associated with the HNCP products at step S3.

The bridge dynamically generates a URL of a corresponding platform and a network address of the generated URL according to the subscription table, such that it performs the mapping between the HNCP-standard message and the UPnP-standard message, resulting in the creation of a UPnP message at step S4.

The UPnP message is transmitted to the home server, such that the HNCP home appliance reads the UPnP message and performs a control function associated with the read UPnP message at step S5.

As apparent from the above description, a home network system including a bridge connected to a home server and a method for operating the same in accordance with the present invention can easily perform mutual-communication between networks (i.e., a control network and a UPnP network) having different communication standards so as to increase compatibility and interoperability of network-purpose home appliances, resulting in an increased control area of home appliances and greater convenience for a user.

Although the home network system and a method for operating the same according to the preferred embodiments of the invention have been disclosed for illustrative purposes, those skilled in the art will appreciate that various modifications, additions and substitutions are possible, without departing from the scope and spirit of the invention as disclosed in the accompanying claims.

1. A home network system comprising:
a control network connected to a plurality of home appliances based on different communication standards for every production company;
a UPnP (Universal Plug and Play) network connected to a plurality of home appliances based on an UPnP communication standard; and
a bridge for composing/listening to a message communicated between the control network and the UPnP network so that it carries out mutual-communication standard conversion.

2. The home network system according to claim 1, wherein the bridge is connected to a home server for controlling operations of the plurality of home appliances contained in the control network and the UPnP network or monitoring state information of the home appliances.

3. The home network system according to claim 2, wherein the bridge is implemented with a software module, so that the software module is built into the home server.

4. The home network system according to claim 1, wherein the home server includes:
a memory for storing device- and user-information of a plurality of home appliances connected over the network;
a network modem for enabling a signal to be transmitted/received over the plurality of home appliances and the network;
a control program drive for operating a control program which controls operations of the home appliances or monitors state information of the same; and
a controller for generating a control signal in response to a control command received via the control program, and performing an operation associated with the generated control signal.

5. The home network system according to claim 4, wherein the home server includes:
an entry unit for receiving operation control commands of the home appliances or an Internet access command from a user; and
an output unit for displaying processed result information associated with the control commands.

6. The home network system according to claim 4, wherein the home server further includes:
an Internet modem connected to a portal server over the Internet, wherein the portable server transmits a remote-control message received from a Webpage and receives state information message of the home appliances connected to the network.

7. The home network system according to claim 1, wherein the bridge includes:
a control network interface for transmitting/receiving a message based on a communication standard of the control network;
a UPnP interpreter for listening to a UPnP message communicating with the UPnP network or composing the UPnP message; and
a bridge manager for converting communication standards of messages transmitted/received via the control network interface and the UPnP interpreter into other communication standards.

8. The home network system according to claim 7, wherein the bridge manager manages unique network addresses of home appliances contained in the control network, and at the same time dynamically generates/assign UPnP network addresses of individual home appliances.

9. The home network system according to claim 8, wherein the bridge manager converts event information generated from the home appliances contained in the control network into a UPnP message with reference to a subscription table in which product information associated with home appliances connected to a network and expiration time of the product information are stored.

10. A method for operating a home network system including a bridge capable of performing mutual conversion of communication standards to implement message transmission/reception between UPnP (Universal Plug and Play) communication standard-based home appliances and other communication standards-based home appliances connected to the same network, the method comprising the steps of:
a) allowing the bridge to refer to a subscription table for storing product information associated with home appliances connected to the network, thereby receiving event information from the home appliances having communication standards other than the UPnP communication standard;
b) composing a UPnP message including a corresponding UPnP network address according to the subscription table; and
c) transmitting the composed UPnP message to a home server so that operations of home appliances associated with the control network are controlled.

11. The method according to claim 10, wherein the step b) includes the steps of:
b1) fetching a user Web-document associated with the home appliances having communication standards other than the UPnP communication standard; and
b2) allowing the bridge to define a URL (Uniform Resource Locator) of a current operation platform as a URL where a user Web-document exists.
